(19) United States
(12) Patent Application Publication
(10) Pub. No.: US 2016/0335579 A1
(43) Pub. Date: Nov. 17, 2016

(54) BUSINESS CONTINUITY PLAN SCORING

(71) Applicant: Target Brands, Inc., Minneapolis, MN (US)

(72) Inventor: Jamie Lee Anderson, Blaine, MN (US)

(21) Appl. No.: 15/151,034

(22) Filed: May 10, 2016

Related U.S. Application Data
(60) Provisional application No. 62/159,650, filed on May 11, 2015.

(51) Int. Cl. G06Q 10/06

(52) U.S. Cl. CPC G06Q 10/06393; G06Q 10/0637

(57) ABSTRACT

A method includes receiving scores for individual components of a continuity plan, forming a plan resiliency score from the scores for the individual components, selecting text based on the plan resiliency score and embedding the selected text in a user interface. A system includes a continuity planning tool for entering information about an extent of a business continuity plan and a plan scoring tool for scoring a business continuity plan based on the information entered using the continuity planning tool, the plan scoring tool producing a resiliency score details user interface that includes a resiliency score for the business continuity plan.

### CROSS-REFERENCE TO RELATED APPLICATION

The present application is based on and claims the benefit of U.S. provisional patent application Ser. No. 62/159,650, filed May 11, 2015, the content of which is hereby incorporated by reference in its entirety.

### BACKGROUND

When disruptive events occur such as natural disasters, power outages, and computer interruptions, businesses can be prevented from performing tasks needed to keep the business in operation. Developing plans to deal with such disruptive events is known as business continuity planning. In such planning, groups within a business develop plans and strategies for dealing with communication system failures, power failures, software failures, and jobsite closures. Such planning can also include identifying alternative sources of needed items if a vendor of the needed items is unable to deliver those items.

The discussion above is merely provided for general background information and is not intended to be used as an aid in determining the scope of the claimed subject matter. The claimed subject matter is not limited to implementations that solve any or all disadvantages noted in the background.

### SUMMARY

A method includes receiving scores for individual components of a continuity plan, forming a plan resiliency score from the scores for the individual components, selecting text based on the plan resiliency score and embedding the selected text in a user interface. A system includes a continuity planning tool for entering information about an extent of a business continuity plan and a plan scoring tool for scoring a business continuity plan based on the information entered using the continuity planning tool, the plan scoring tool producing a resiliency score details user interface that includes a resiliency score for the business continuity plan.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of a business continuity planning system in accordance with one embodiment.

FIG. 2 is a flow diagram for generating and scoring business continuity plans.

FIG. 3 is an example of a user interface used to score a business continuity plan.

FIG. 4 is an example of a user interface for entering canned text for various resiliency scores.

FIG. 5 is an example of a user interface providing a resiliency score detail page.

FIG. 6 is an example of a user interface for creating a new resiliency score activity record.

FIG. 7 is an example of a user interface for logging awareness training activities.

FIG. 8 is an example of a user interface for recording business continuity plan review activities.

FIG. 9 is an example of a user interface for logging a notification exercise activity.

FIG. 10 is an example of a user interface for logging a simulation exercise activity.

FIG. 11 is an example of a user interface for logging a table-top exercise activity.

FIG. 12 is an example of a user interface for logging a continuity plan activation.

FIG. 13 is an example of a user interface for logging resiliency score activity findings.

FIG. 14 is a block diagram of a computing device.

### DETAILED DESCRIPTION

Embodiments described below provide a system for scoring business continuity plans to provide a resiliency score for each team or division in a business and for reporting business continuity planning readiness across teams to leadership of a business.

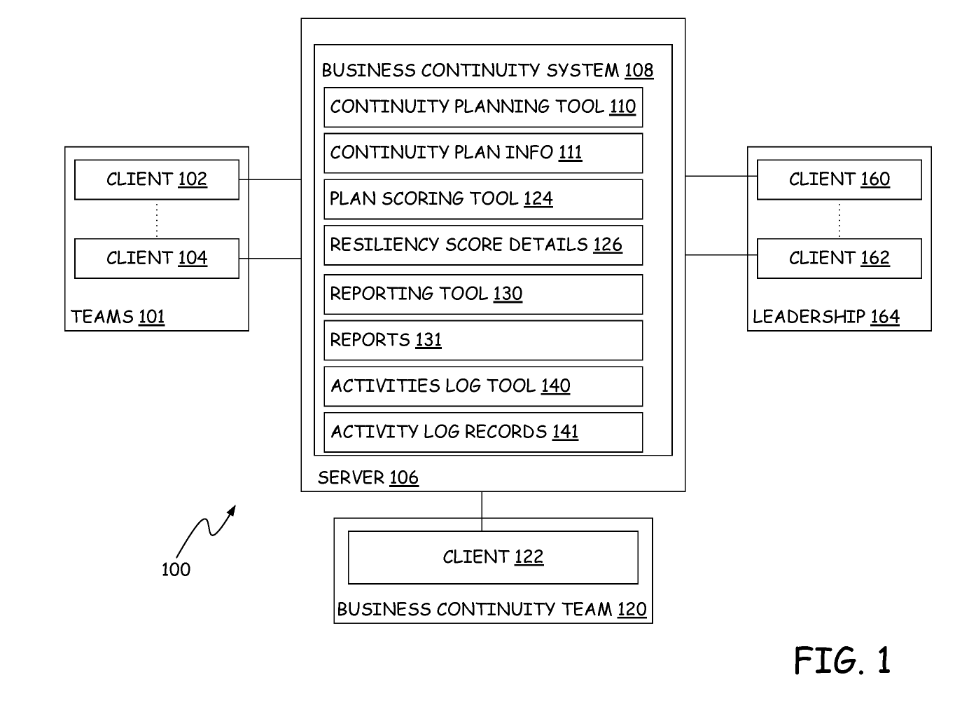

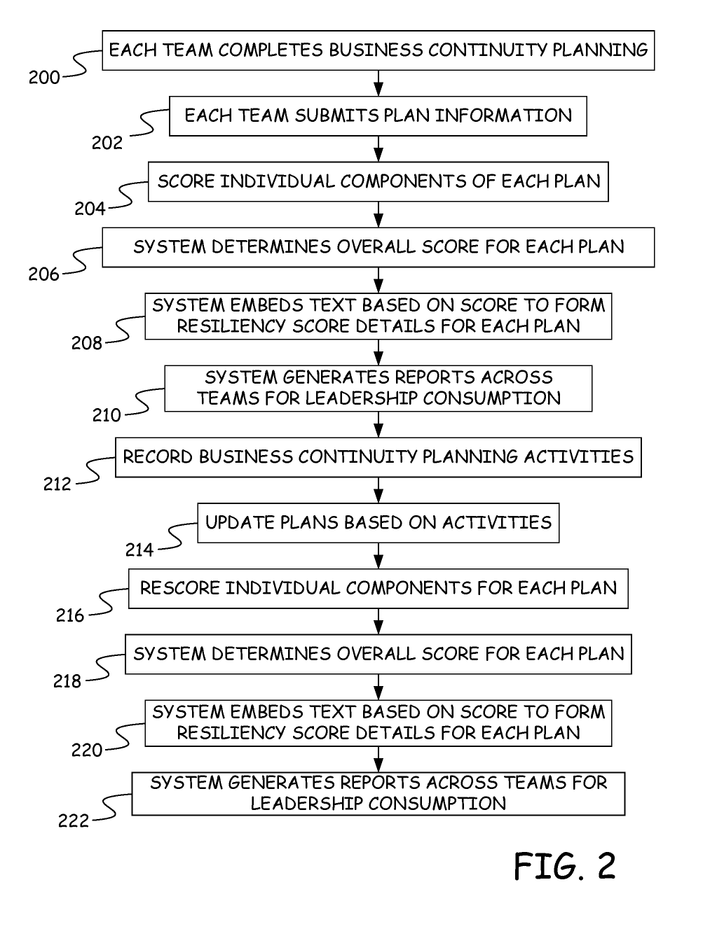

FIG. 1 provides a block diagram of a system 100 used for scoring business continuity plans and FIG. 2 provides a flow diagram for scoring such plans. In step 200 of FIG. 2, each team of a plurality of teams 101 performs business continuity planning. At step 202, each team uses one or more client devices 102 and 104 to communicate with a server 106. In particular, client devices 102 and 104 are used to access business continuity system 108, which includes a business continuity planning tool 110. Business continuity planning tool 110 includes a series of user interfaces that allows each team to indicate the extent of their business continuity plan resulting in continuity plan information 111 for each team.

At step 204, a business continuity team 120 uses a client device 122 to access server 106 and in particular to access a plan scoring tool 124 in business continuity systems 108. Using plan scoring tool 124, business continuity team 120 scores the individual components of each team's plan information 111.

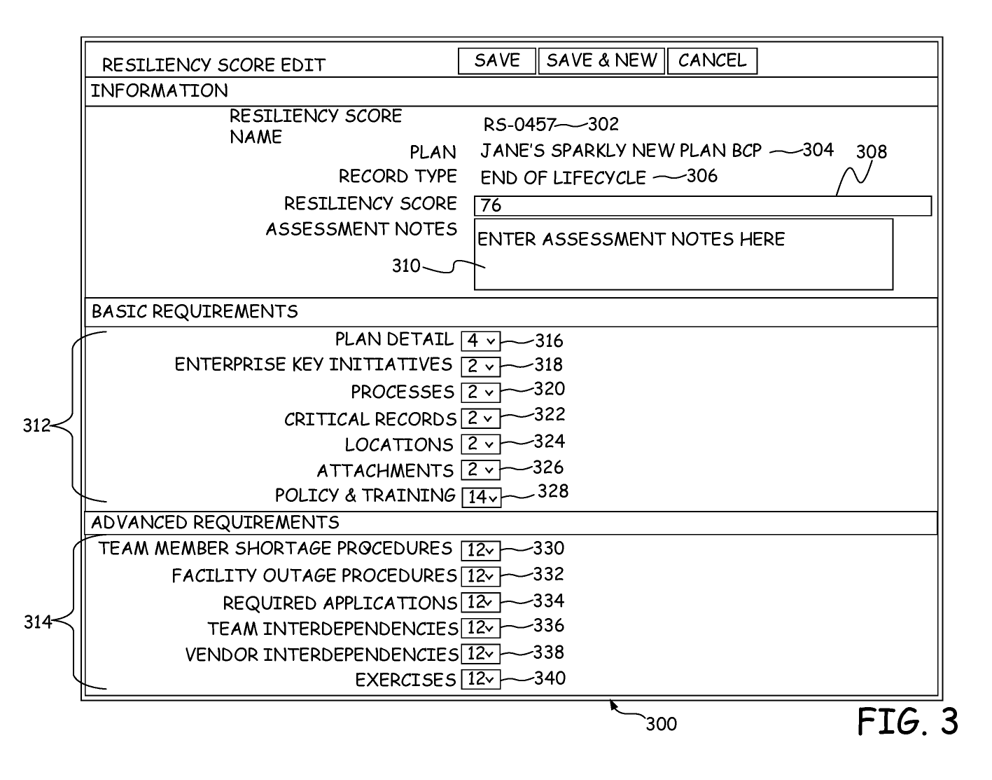

FIG. 3 provides a user interface that can be used by business continuity team 120 to score a team's business continuity plan. User interface 300 of FIG. 3 includes a resiliency score name 302, a plan name 304, a record type 306, a resiliency score 308 and assessment notes 310. Resiliency score name 302 is a unique identifier for this particular resiliency score and plan name 304 identifies a particular plan being scored. Record type 306 identifies whether this is a mid-lifecycle or end of lifecycle score where a mid-lifecycle score is determined for an initial business continuity plan and an end of lifecycle score is provided for an updated business continuity plan. Resiliency score 308 is an overall score for the business continuity plan which is formed based on scores for individual components of the business continuity plan. Scores for those individual components are entered in basic requirements section 312 and advanced requirements section 314. In basic requirements section 312, scores are provided for attributes of the plan such as plan detail 316, enterprise key initiatives 318, processes 320, critical records 322, locations 324, attachments 326, and policy and training 328. Advanced requirements section 314 includes scores for plan attributes such as team member shortage procedures 330, facility outage procedures 332, required applications 334, team interdependencies 336, vendor interdependencies 338 and exercises 340. Each attribute has an associated score. Required applications attribute 334 and vendor interdependencies attribute 338 can receive a score of “not applicable” (N/A) if the requirement is not applicable to the plan. A score of N/A is calculated into the final resiliency score as the equivalent of the highest points allowed for that requirement.

After a person on business continuity team 120 enters the individual scores for plan attributes 316-340, plan scoring tool 124 sums the individual scores together to form an overall score for the plan and displays this overall score on user interface 300 as resiliency score 308 at step 206. Plan scoring tool 124 then selects text to be embedded in a resiliency score details page based on the resiliency score at step 208.

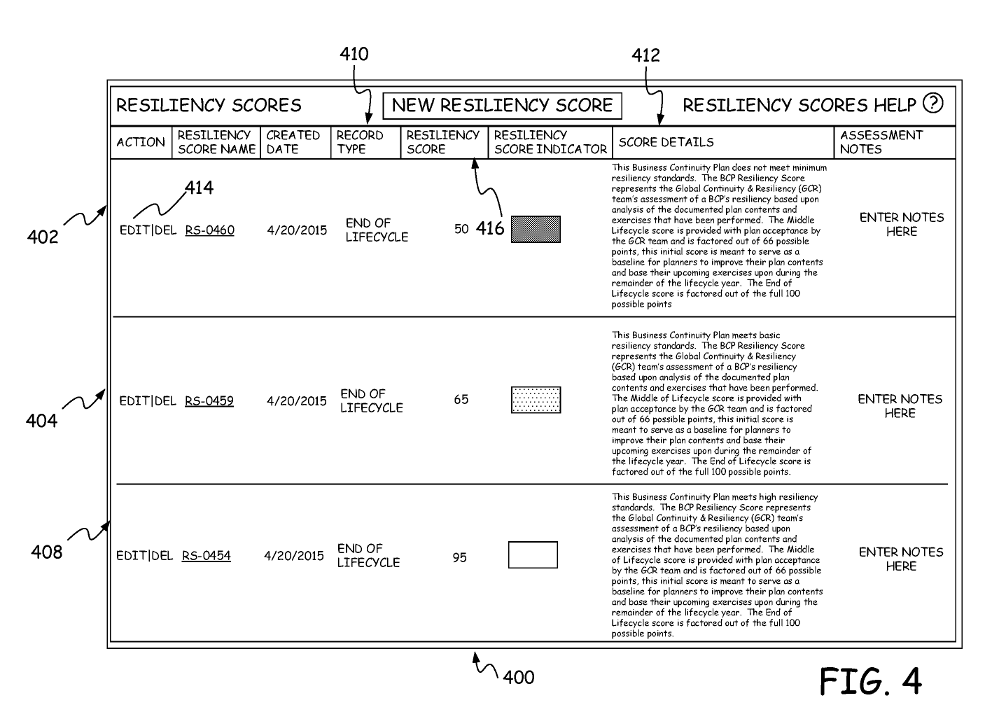

FIG. 4 provides an example of a user interface 400 that can be used to generate the text to be embedded for various resiliency scores. User interface 400 includes three rows 402, 404, and 408 with each row being associated with a different resiliency score as indicated by column 410. If the resiliency score for a plan is at least as great as the resiliency score for the row but not as great as the resiliency score for the next row, the text in score details column 412 of the row is embedded in the resiliency score details page. Using edit button, such as edit button 414, a member of the business continuity team 120 can change the text in score details 412 or change the resiliency score for the respective row. In accordance with some embodiments, each row has a resiliency score indicator which is a color or pattern as provided in resiliency score indicator column 416. This resiliency score indicator can be provided on the resiliency score details page generated for the business continuity plan. The resulting resiliency score details are stored as resiliency score details 126 in business continuity system 108 and can be accessed by clients 102 and 104 of teams 101, client device 122 of business continuity team 120 and clients 160 and 162, used by people in leadership 164.

The possible scoring for each attribute of a continuity plan is described in the tables below for a first embodiment.

MINIMUM REQUIREMENTS - 28 possible points

| Basic | 4 | Plan Detail section is complete and includes an Owner and Backup, with |
|---|---|---|
| Requirements | | current contact information, as well as an appropriate Plan Approver |
| | 2 | Enterprise Key Initiatives have been selected or “Not Applicable” has been |
| | | chosen |
| | 2 | Processes section is complete for one or more critical processes which |
| | | include description, requested recovery time and impact |
| | 2 | Critical Records have been documented and include description and |
| | | location information |
| | 2 | Locations have all been entered along with team members, contractors and |
| | | Business Continuity Plan minimum requirements information |
| | 2 | Attachments referenced with the Business Continuity Plan have been added |
| | | and a document listing team contact information is attached |
| Policy & | REQUIREMENTS: 1) New Planners: Complete Certification 2) Acknowledge | |
| Training | Target Continuity Program Policy 3) Complete Annual Training | |
| | 2 | Some of the above requirements have been met |
| | 4 | The Owner AND Backup have met ALL of the above requirements |
| | 4 | The Owner, Backup and Plan Approver have met ALL of the above |
| | | requirements |
| | 4 | Planner led awareness training completed with team and leadership |
| | | including Plan Approver (log as Resiliency Score Activity) |

ADVANCED REQUIREMENTS - 72 possible points

| | | |
|---|---|---|
| Team | 2 | Team Member Shortage Procedure includes alternate resources such as |
| Member | | team members, contractors, and/or vendors that have been cross-trained |
| Shortage | 2 | Prioritization of work with limited resources and identification of key |
| Procedures | | decision makers. |
| | 2 | Workaround strategy includes location of detailed procedural |
| | | documentation |
| | 3 | Planner led Tabletop Exercise held with alternate resources to discuss |
| | | Team Member Shortage Procedures (log as Resiliency Score Activity) |
| | 3 | Planner led Simulation Exercise held with alternate resources including |
| | | transfer of work and return to normal procedures (log as Resiliency Score |
| | | Activity) |
| Facility | 2 | Facility Outage Procedure includes alternate work location strategy |
| Outage | | (virtual, physical, or vendor) |
| Procedures | 2 | Prioritization of work with limited resources (technical assets, etc.) |
| | 2 | Workaround strategy includes a communication plan to stay connected |
| | | with team members, leaders, and interdependencies. |
| | 3 | Planner led Tabletop Exercise held to discuss Facility Outage Procedures |
| | | (log as Resiliency Score Activity) |
| | 3 | Planner led Simulation Exercise held including unannounced relocation to |
| | | alternate work locations (log as Resiliency Score Activity) |
| Required | | NOTE: If Required Applications do not exist this section will be scored |
| Applications | | “N/A” and the Resiliency Score will be calculated accordingly. If risk is |
| | | accepted for all Required Applications, a score of “0” will be given. Any |
| | | applications supported by vendors should be listed as a Vendor |
| | | Interdependency instead. |
| | 2 | Required Application(s) have been identified and some have documented |
| | | manual workarounds, some have risk acceptance |
| | 2 | Workarounds include sustainability and return to normal procedures for all |
| | | applications |
| | 2 | Data security classifications and controls have been well documented |
| | | within workarounds |
| | 3 | Planner led Tabletop Exercise held to discuss Required Application |
| | | workaround procedures (log as Resiliency Score Activity) |
| | 3 | Planner led Simulation Exercise held including performing critical |
| | | processes without Required Applications (log as Resiliency Score Activity) |
| Team Inter- | 2 | Team interdependencies have been identified |
| dependencies | 2 | Team interdependencies include a workflow description as well as a |
| | | primary contact |
| | 2 | Team interdependencies include notes about timing and triggers for |
| | | interacting with the interdependent teams |
| | 3 | Business Continuity Plan Review held with at least one Team |
| | | Interdependency (log as Resiliency Score Activity) |
| | 3 | Team Interdependencies included as participants in a planner led exercise |
| | | (log as Resiliency Score Activity) |
| Vendor Inter- | | NOTE: If vendor interdependencies do not exist this section will be scored |
| dependencies | | “N/A” and the resiliency score will be calculated accordingly. If risk is |
| | | accepted for all Vendor Interdependencies, a score of “0” will be given. |
| | | Vendor supported applications should be listed as a Vendor Interependency |
| | 2 | Vendor interdependencies have been identified and some have documented |
| | | workarounds, some have risk acceptance |
| | 2 | All vendor interdependencies include a workflow description as well as |
| | | vendor contact notes |
| | 2 | Workarounds including alternative venders, sustainability and return to |
| | | normal procedures for all vendors |
| | 3 | Planner led tabletop exercise held with Vendor Interdependencies to |
| | | discuss workaround procedures (log as Resiliency Score Activity) |
| | 3 | Planner led Simulation Exercise held with Vendor Interdependencies |
| | | including transfer of work and return to normal procedures (log as |
| | | Resiliency Score Activity) |
| Exercises | 2 | Participated in Global Continuity and Resiliency Team led |
| Tier 1 & Tier | | Notification Exercise |
| 2 BCPs | 2 | Completed a planner led Notification Exercise using the team contact |
| | | list (log as Resiliency Score Activity) |
| | 2 | Completed an exercise that was led by a team member or leader other |
| | | than the plan Owner or Backup (log as Resiliency Score Activity) |
| Exercises | 2 | Participated in Global Continuity and Resiliency team led Tabletop |
| Tier 1 BCPs | | Exercise (log as Required Lifecycle Exercise and include participants |
| Only | | and findings) |
| | 2 | Participated in Global Continuity and Resiliency team led Simulation |
| | | Exercise (log as Required Lifecycle Exercise and include participants |
| | | and findings) |
| | 2 | All exercise findings have been remediated |
| Resiliency | 0-50 | This Business Continuity Plan does not meet minimum resiliency |
| Score | | standards |
| | 51-79 | This Business Continuity Plan meets basic resiliency standards |
| | 80-100 | This Business Continuity Plan meets high resiliency standards |

In a second embodiment, the following scoring is used:

BASIC REQUIREMENTS - 30 possible points

| | | |
|---|---|---|
| Basic | 0/5 | Plan Detail section is complete and includes an Owner and Backup, with |
| Requirements | | current contact information, as well as an appropriate Plan Approver |
| | 0/5 | Strategic Corporate Initiatives have been selected or “Not Applicable” has |
| | | been chosen |
| | 0/5 | Processes section is complete for one or more critical processes which |
| | | include pyramid, description, requested recovery time and impact |
| | 0/5 | Critical Records have been documented and include description and |
| | | location information |
| | 0/5 | Locations have all been entered along with team members, contractors and |
| | | Business Continuity Plan minimum requirements information |
| | 0/5 | Attachments referenced with the Business Continuity Plan have been added |
| | | and a document listing team contact information is attached |

ADVANCED REQUIREMENTS - 70 possible points

| Policy & | REQUIREMENTS: 1) Complete Business Continuity Planner Certification 2) | |
|---|---|---|
| Training | Acknowledge Target Continuity Program Policy 3) Log Annual Training | |
| | 0 | None of the above requirements have been met |
| | 2 | Some of the above requirements have been met |
| | 4 | EITHER the Owner OR Backup have met ALL of the above requirements |
| | 6 | BOTH the Owner AND Backup have met ALL of the above requirements |
| | 8 | Awareness training has been held with EITHER leadership OR team and |
| | | logged in Fusion |
| | 10 | Awareness training has been held with BOTH leadership AND team and |
| | | logged in Fusion |
| Team | 0 | A team member shortage procedure has not been documented |
| Member | 2 | Workaround documentation is minimal (example: all team members are |
| Shortage | | cross trained) |
| Procedures | 4 | A workaround strategy has been well documented and includes critical |
| | | procedures and prioritization of work |
| | 6 | Alternative resources (team members, contractors, vendors) have been |
| | | clearly identified and trained on specific tasks |
| | 8 | A team led tabletop exercise has been held with alternative resources to |
| | | discuss Team Member Shortage workaround procedures and logged in |
| | | Fusion |
| | 10 | A team led simulation exercise has been held with alterative resources |
| | | including transferring work and return to normal procedures and logged in |
| | | Fusion |
| Facility | 0 | A facility outage procedure has not been documented |
| Outage | 2 | Workaround documentation is minimal (example: all team members can |
| Procedures | | work remotely) |
| | 4 | A workaround strategy has been well documented for alternate site and/or |
| | | work remotely (exempt, non-exempt, laptops not immediately available) |
| | 6 | A communication plan and technology requirements have been |
| | | documented |
| | 8 | A team led tabletop exercise has been held to discuss Facility Outage |
| | | workaround procedures and logged in Fusion |
| | 10 | A team led simulation exercise has been held including UNANNOUNCED |
| | | relocation to alternate site and/or work remotely and logged in Fusion |
| Required | | NOTE: if no required applications exist, or only vendor supported, this |
| Applications | | section will not be scored and the resiliency score will be calculated |
| | | accordingly |
| | 0 | Application(s) have been identified and none have documented |
| | | workarounds all have risk acceptance |
| | 2 | Application(s) have been identified and some have documented |
| | | workarounds some have risk acceptance |
| | 4 | Workarounds including sustainability and return to normal procedures |
| | | documented for all applications (not relying on other corporate systems) |
| | 6 | Data security procedures and controls have been well documented within |
| | | workarounds |
| | 8 | A team led tabletop exercise has been held to discuss Required Application |
| | | workaround procedures and logged in Fusion |
| | 10 | A team led simulation exercise has been held including performing critical |
| | | processes without Required Applications and logged in Fusion |
| Team Inter- | 0 | No team interdependencies have been identified |
| dependencies | 2 | At least one team interdependency has been identified |
| | 4 | All team interdependencies include a workflow description as well as a |
| | | primary contact |
| | 6 | The team interdependencies include notes about timing and triggers for |
| | | interacting with the interdependent teams |
| | 8 | Contacts from the identified team interdependencies have been included as |
| | | participants in a team led exercise which has been logged in Fusion |
| | 10 | A Business Continuity Plan review has been completed for at least one |
| | | team interdependency and logged in Fusion |
| Vendor Inter- | | NOTE: if no vendor interdependencies exist this section will not be |
| dependencies | | scored and the resiliency score will be calculated accordingly |
| | 0 | Vendor(s) have been identified and none have documented |
| | | workarounds all have risk acceptance |
| | 2 | Vendor(s) have been identified and some have documented |
| | | workarounds some have risk acceptance |
| | 4 | All vendor interdependencies include a workflow description as well |
| | | as vendor contact notes |
| | 6 | Workarounds including alternative venders, sustainability and return |
| | | to normal procedures have been documented for all vendors |
| | 8 | A team led tabletop exercise has been held with identified vendors to |
| | | discuss Vendor Interdependency workaround procedures and logged |
| | | in Fusion |
| | 10 | A team led simulation exercise has been held with identified vendors |
| | | including transferring work and return to normal procedures and |
| | | logged in Fusion |
| Exercises | | REQUIRED LIFECYCLE EXERCISES: 1) Global Continuity and |
| | | Resiliency Tabletop Exercise 2) Global Continuity and Resiliency |
| | | Simulation Exercise 3) Global Continuity and Resiliency Notification |
| | | Exercise (logged in Fusion by Global Continuity and Resiliency) |
| | 0 | None of the required Global Continuity and Resiliency Lifecycle |
| | | Exercises have been completed and logged in Fusion |
| | 2 | Two of the three required Global Continuity and Resiliency Lifecycle |
| | | Exercises have been completed and logged in Fusion |
| | 4 | All three of the required Global Continuity and Resiliency Lifecycle |
| | | Exercises have been completed and logged in Fusion |
| | 6 | The Global Continuity and Resiliency Tabletop Exercise and Global |
| | | Continuity and Resiliency Simulation Exercise include a listing of |
| | | participants and findings that have been remediated |
| | 8 | A team led notification exercise has been held and logged in Fusion |
| | 10 | A team led exercise of the Business Continuity Plan has been executed |
| | | by someone other than the plan Owner or backup and logged in Fusion |
| Resiliency | 0-59 | This Business Continuity Plan does not meet minimum resiliency |
| Score | | standards |
| | 60-72 | This Business Continuity Plan meets basic resiliency standards |
| | 73-89 | This Business Continuity Plan meets moderate resiliency standards |
| | 90-100 | This Business Continuity Plan meets high resiliency standards |

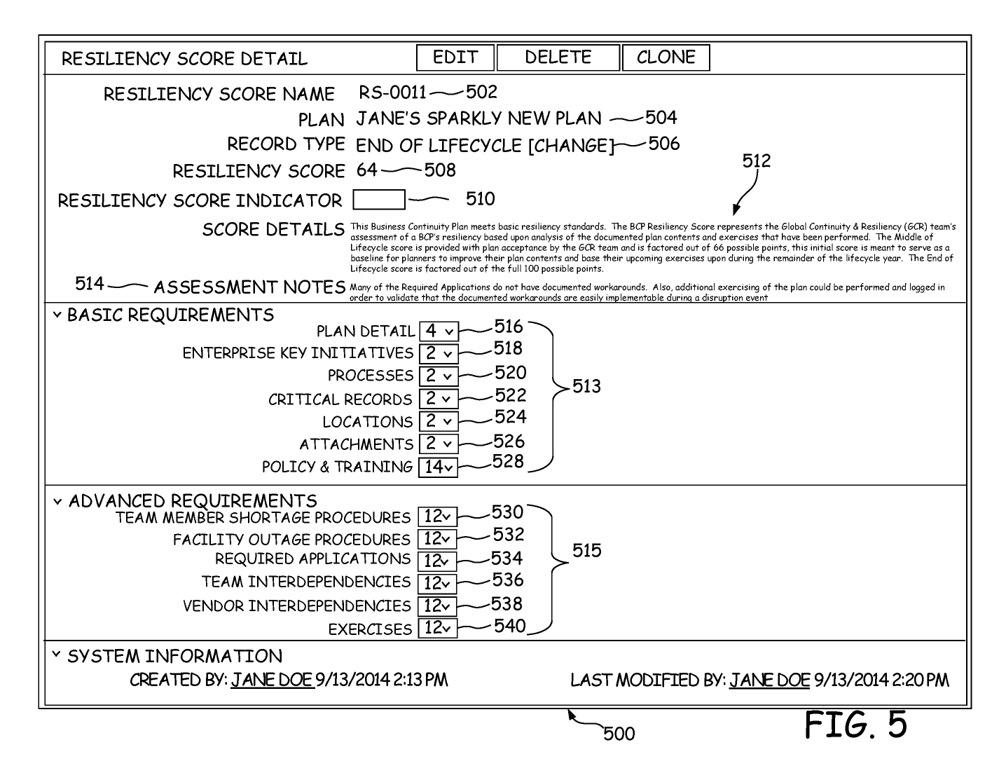

FIG. 5 provides an example of a resiliency score detail user interface showing the resiliency score details 126 for a continuity plan. Resiliency score detail user interface 500 includes a resiliency score name 502 that identifies the resiliency score, a plan name 504, a record type 506, a resiliency score 508, a resiliency score indicator 510, resiliency score details text 512 and assessment notes 514. Score details text 512 is the text embedded automatically in resiliency score details 126 by plan scoring tool 124. Resiliency score indicator 510 and score details text 512 are both added to the resiliency score details user interface 500 in response to the resiliency score 508 and the corresponding entry form using user interface 400 of FIG. 4. Resiliency score details user interface 500 also includes the scores of each of the components assigned using user interface 300 including plan detail score 516, enterprise key initiatives 518, processes 520, critical records 522, locations 524, attachments 526, and policy and training 528 of basic requirements section 513. Basic requirements section 513 corresponds to basic requirements section 312 of user interface 300. Resiliency score details user interface 500 also includes scores received for advanced requirements 515 including team member shortage procedures 530, facility outage procedures 532, required applications 534, team interdependencies 536, vendor interdependencies 538 and exercises 540. Advanced requirements section 515 corresponds to advanced requirements section 314 of user interface 300.

At step 210 of FIG. 2, business continuity team 120 may use reporting tools 130 through client device 122 to generate reports 131 that provide resiliency scores across multiple teams or divisions of a business. Such reports can be viewed using client devices 160 and 162 by leadership 164.

After step 210, business continuity planning is considered to be in its mid-lifecycle where an initial business continuity plan has been formed for each team, resiliency scores have been provided for each plan and reports have been generated for leadership 164. Teams 101 can then improve their business continuity plan by comparing their scores to the available scores using the resiliency scoring guide described in the table above. In particular, users are able to schedule activities and plan exercises to improve their scores for their business continuity plan.

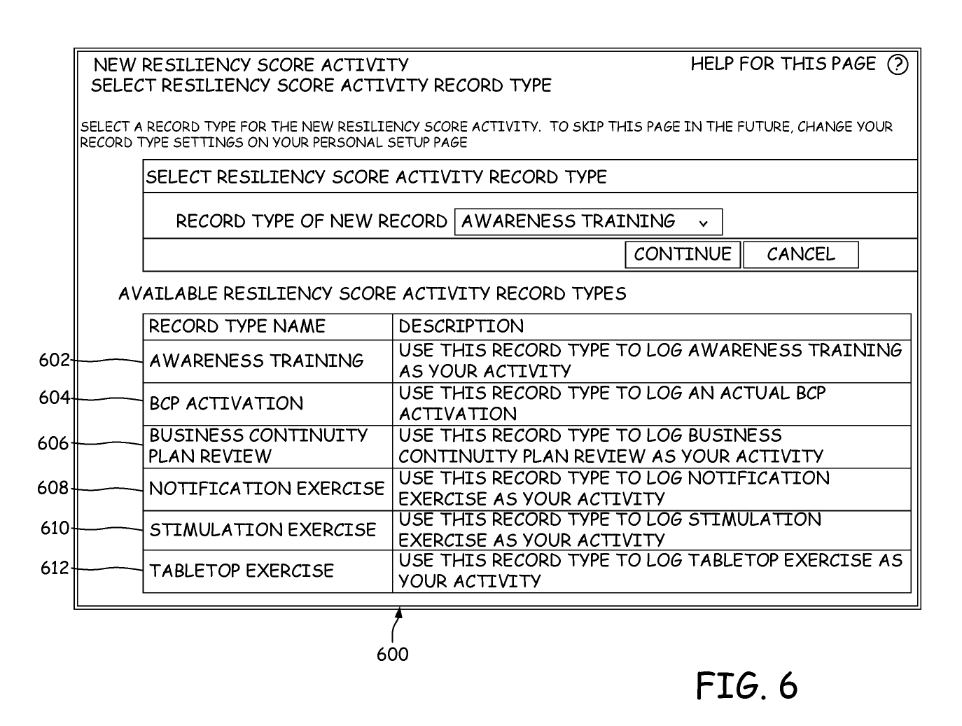

FIG. 6 provides a user interface 600 which is generated by an activities log tool 140 in business continuity system 108 and which can be used to create a new activity log. Possible activities include awareness training 602, business continuity plan activation 604, business continuity plan review 606, notification exercise 608, simulation exercise 610 and tabletop exercise 612. At step 212, a team 101 performs one of the planning activities and records the planning activity by creating the appropriate activity log record 141 using user interface 600.

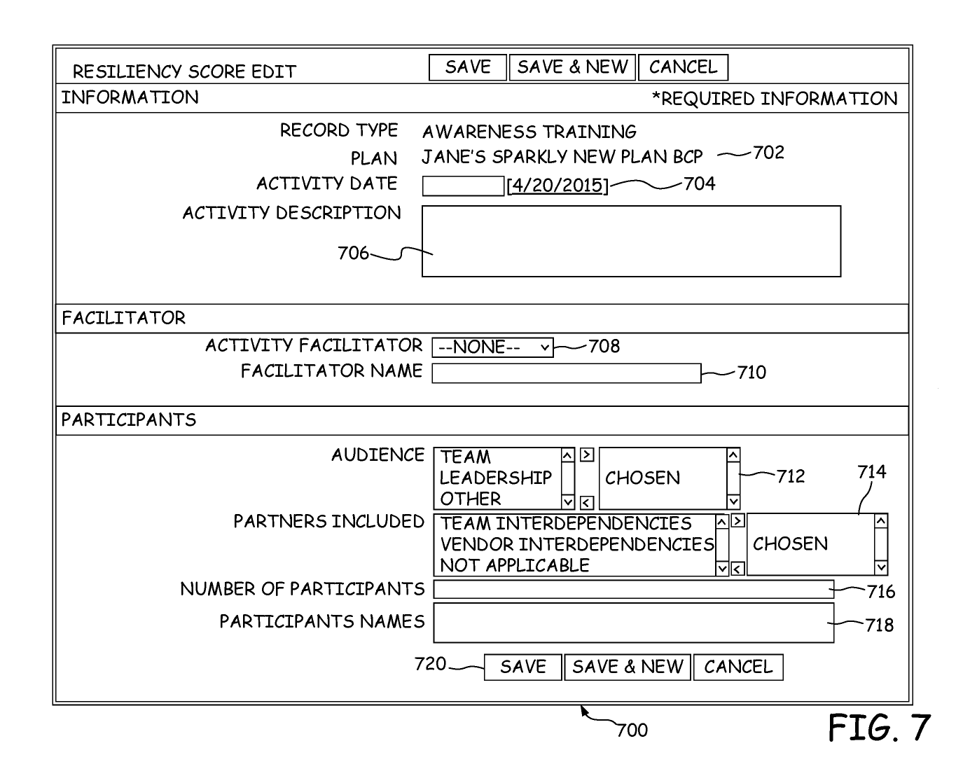

FIG. 7 provides a user interface 700 for recording an awareness training activity. Awareness training involves meeting with team members and/or leaders to provide them with an overview of the business continuity plan, including discussing the critical processes and interdependencies that have been documented as well as the workarounds that would be enacted, if required, to continue operations. This helps the team members and leaders to understand their roles and responsibilities during a disruptive event. The information recorded in user interface 700 includes plan name 702, activity date 704 and a description of the activities 706. User interface 700 also includes an indication of whether a facilitator was used 708 and the name of the facilitator 710. Participants in the activity are described based on the general category of participants 712, whether partners are included 714, the number of participants 716 and the participant's name 718. When the information for user interface 700 has been entered, it may be saved using save control 720.

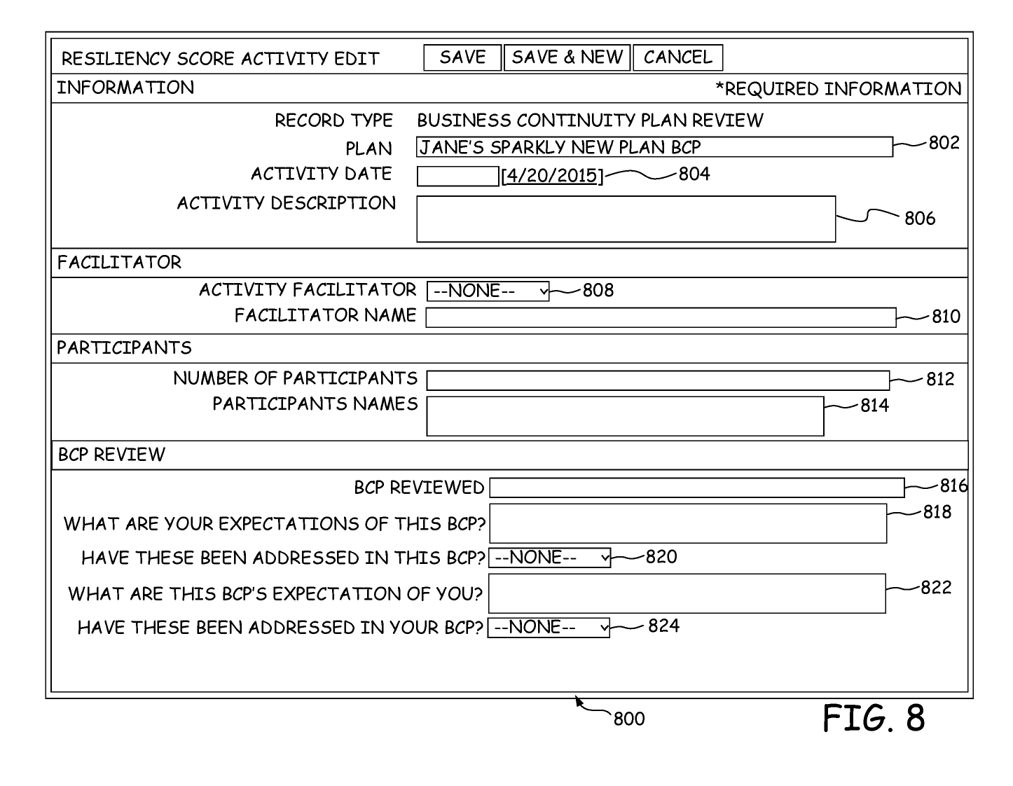

FIG. 8 provides an example of a user interface 800 that can be used to log a business continuity plan review activity. A business continuity plan review involves meeting with a team that is listed as an interdependency to review each other's plans and discuss expectations of each other during a disruption event. The goal is to identify opportunities to enhance plan contents in order to better support each other and to enable the continuation of critical processes. The information collected in user interface 800 includes the plan name 802, activity date 804 and a description of the activity 806. Plan name 802 is referred to as the current plan and the team associated with that plan is referred to as the current team within the context of user interface 800. The current team is also referred to as “you” in user interface 800.

User interface 800 also includes an indication 808 of whether a facilitator was present 808 and the name 810 of that facilitator. The number of participants 812 and the names of those participants 814 are also recorded. The business continuity plan of another team or division that was reviewed is provided in field 816 and a short description of the expectations that the current team had for the business continuity plan of the other team are written into field 818. An indication of whether these expectations have been addressed in the business continuity plan listed in field 816 is indicated in field 820. The expectations of the business continuity plan listed in field 816 for the current team are written in field 822. An indication of whether the current team's business continuity plan takes into consideration the expectations listed in field 822 is indicated using field 824.

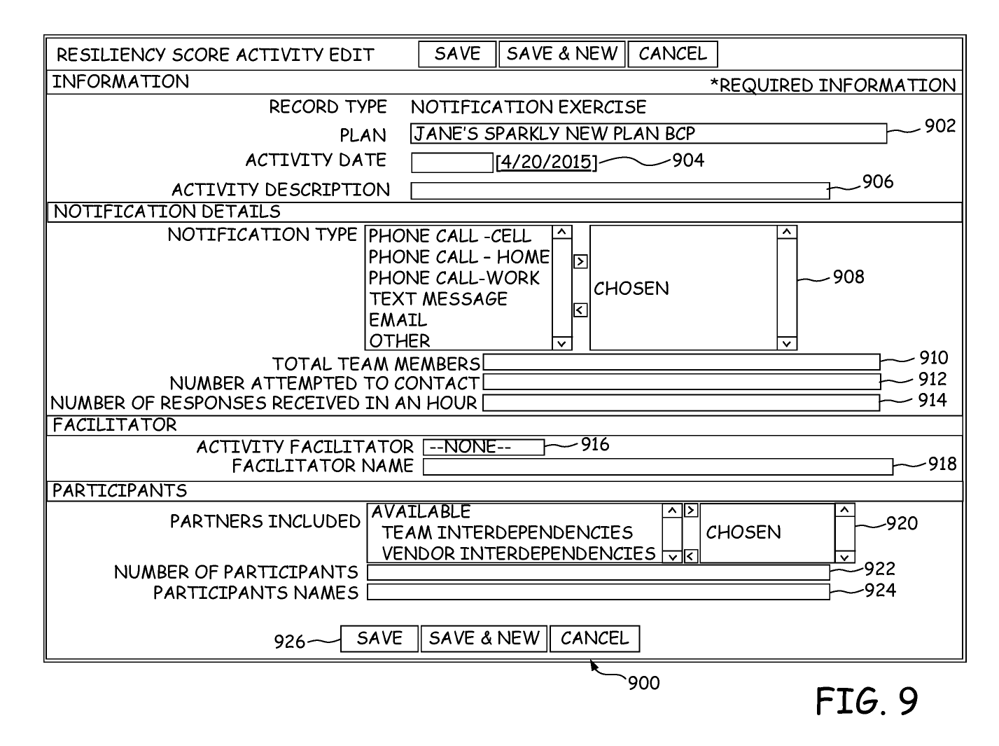

FIG. 9 provides a user interface 900 for logging a notification exercise activity. A notification exercise involves leveraging the contact information that is listed within the team roster and testing the ability to reach team members via a notification method such as a phone call, text messaging, email, etc. Planners should identify how many responses are received within an hour. User interface 900 includes plan name field 902, activity date field 904 and activity description field 906. Notification types that are being tested are found in field 908, the total number of team members is provided in field 910, the number attempted to contact is found in field 912 and the number of responses received in an hour is found in field 914. If a facilitator is used, this is indicated in field 916 along with the name of the facilitator in field 918. Partners that are made part of the exercise are indicated in field 920 and the number of participants and the participant's names are found in fields 922 and 924, respectively. When the data in user interface 900 has been filled in, the data may be saved using save control 926.

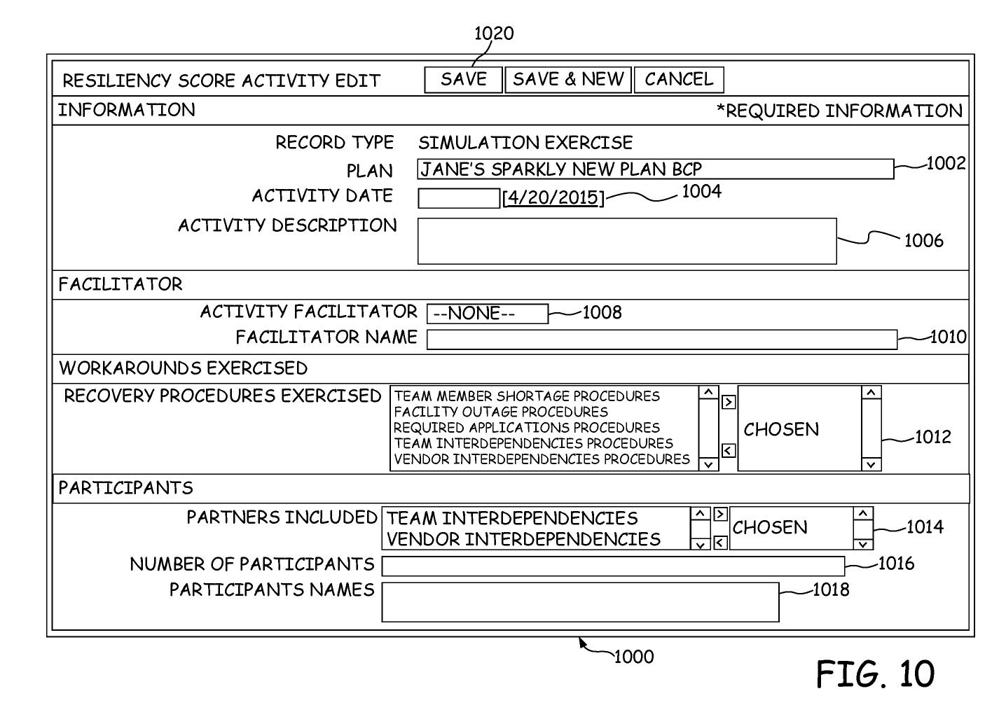

FIG. 10 provides a user interface 1000 that can be used to log a simulation exercise activity. A simulation activity involves: 1) partnering with alternate resources and/or vendors to simulate transferring of work and returning back to normal procedures, 2) performing an unannounced team relocation to a designated alternate site and/or working remotely, 3) performing critical processes without required applications. User interface 1000 includes a plan name field 1002, an activity date 1004 and an activity description 1006. If a facilitator is used for the exercise, this is indicated by field 1008 and the facilitator's name is placed in field 1010. Workarounds that are being exercised are chosen in field 1012, such as team member shortage procedures, facility outage procedures, required application procedures, team interdependency procedures and vendor interdependency procedures, for example. Participants in the exercise are indicated by partners included field 1014, the number of participants 1016 and the names of the participants 1018. When the information has been entered in user interface 1000, the data may be saved using save control 1020.

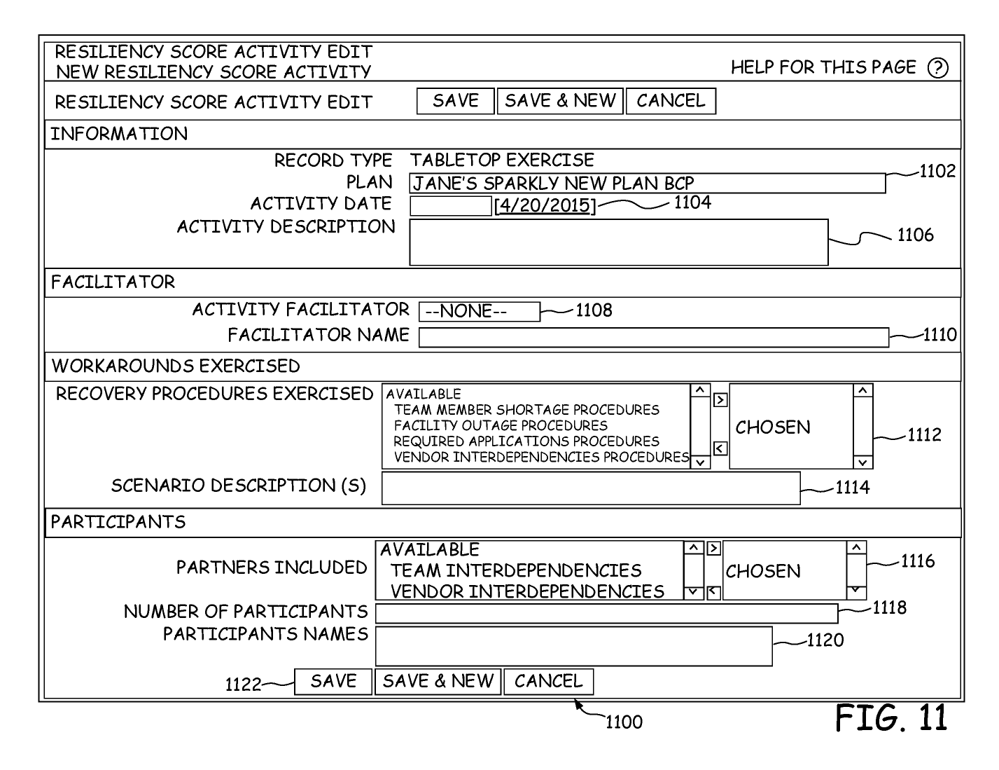

FIG. 11 provides a user interface 1100 for logging a tabletop exercise activity. The tabletop exercise involves: 1) meeting with team and alternate resources to discuss team member shortage, facility outage, and/or required application workaround procedures, 2) meeting with identified vendor interdependencies to discuss vendor interdependency workaround procedures. User interface 1100 includes plan name 1102, activity date 1104 and activity description 1106. If a facilitator is used, this is indicated by pulldown 1108 and by including the facilitator's name 1110. Workarounds that are being exercised are indicated using control 1112, which allows multiple procedures to be selected such as team member shortage procedures, facility outage procedures, required application procedures and vendor interdependency procedures. A description of the scenario 1114 may be provided indicating what scenario(s) are being tested. The participants in the exercise may be indicated using control 1116, number of participants 1118 and the names of participants 1120. Once the information is stored on user interface 1100, it may be saved using control 1122.

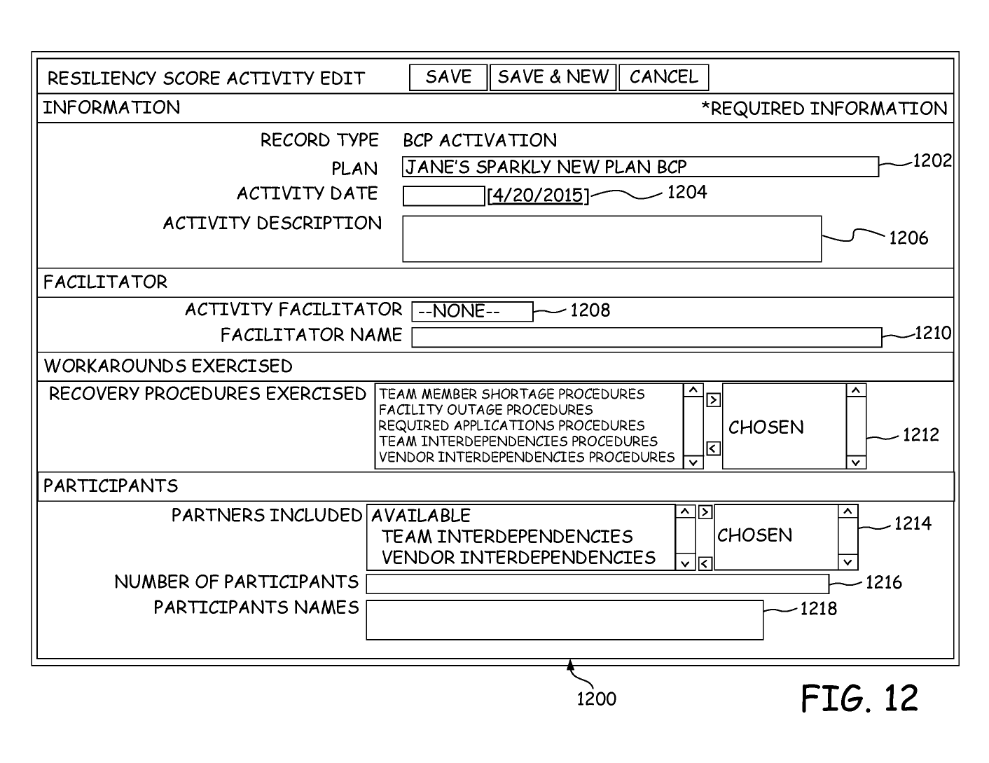

FIG. 12 provides a user interface 1200 for logging a business continuity plan activation activity. A business continuity plan activation activity involves actually using a plan in response to a disruption event in order to gauge how often plans are enacted and identify opportunities for plan improvement based on findings from the activation. In other words, the activity is an actual business continuity plan activation. User interface 1200 includes field 1202 for the name of the plan, an activity date 1204 and a description 1206. If an activity facilitator was used, this is indicated by pulldown 1208 and the facilitator's name is included in field 1210. Workarounds that were exercised during the activation of the plan are selected using control 1212, such as team member shortage procedures, facility outage procedures, required application procedures, team interdependency procedures, and vendor interdependencies. Categories of participants that took part in the business continuity plan activation are selected using control 1214 and the number of participants and the name of the participants are entered into fields 1216 and 1218, respectively.

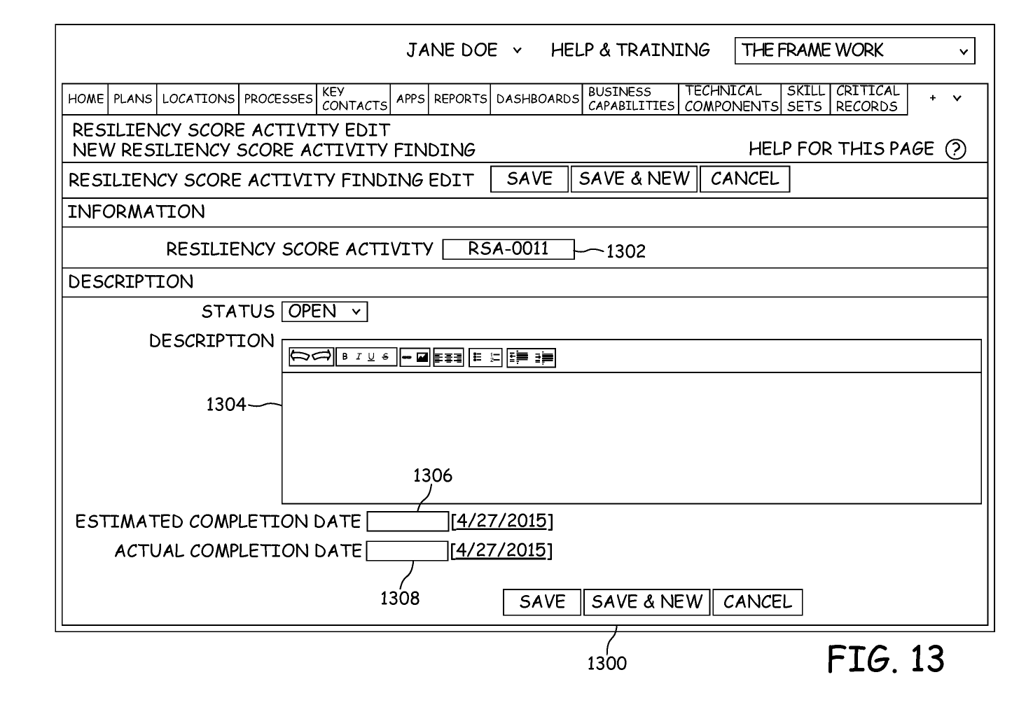

FIG. 13 provides a user interface 1300 that is displayed after one or more of the activity pages shown in FIGS. 7-12 have been displayed. User interface 1300 allows planners to document any findings that occur as a result of the activity or event. Planners have the ability to enter multiple findings and track them to a resolution. In user interface 1300, resiliency score activity 1302 provides a unique identifier for the record and the user is able to insert a description of the findings and actions that need to be taken 1304, an estimated completion date for the actions 1306 and an actual completion date 1308.

After teams have performed their activities, their plans are updated based on their activities using business continuity planning tool 110 at step 214. At step 216, business continuity team 120 uses plan scoring tool 124 to rescore the individual components of each plan based on the activities. At step 218, plan scoring tool 124 determines an overall score for each plan, and at step 220, plan scoring tool 124 automatically embeds text based on the scores to form resiliency score details 126 for each plan. Business continuity team 120 can then use reporting tool 130 to generate reports for consumption by leadership 164 at step 222. The scores determined at step 218 and the text embedded into the resiliency score details at step 222 are considered to be done at an end of lifecycle for the business continuity plan.

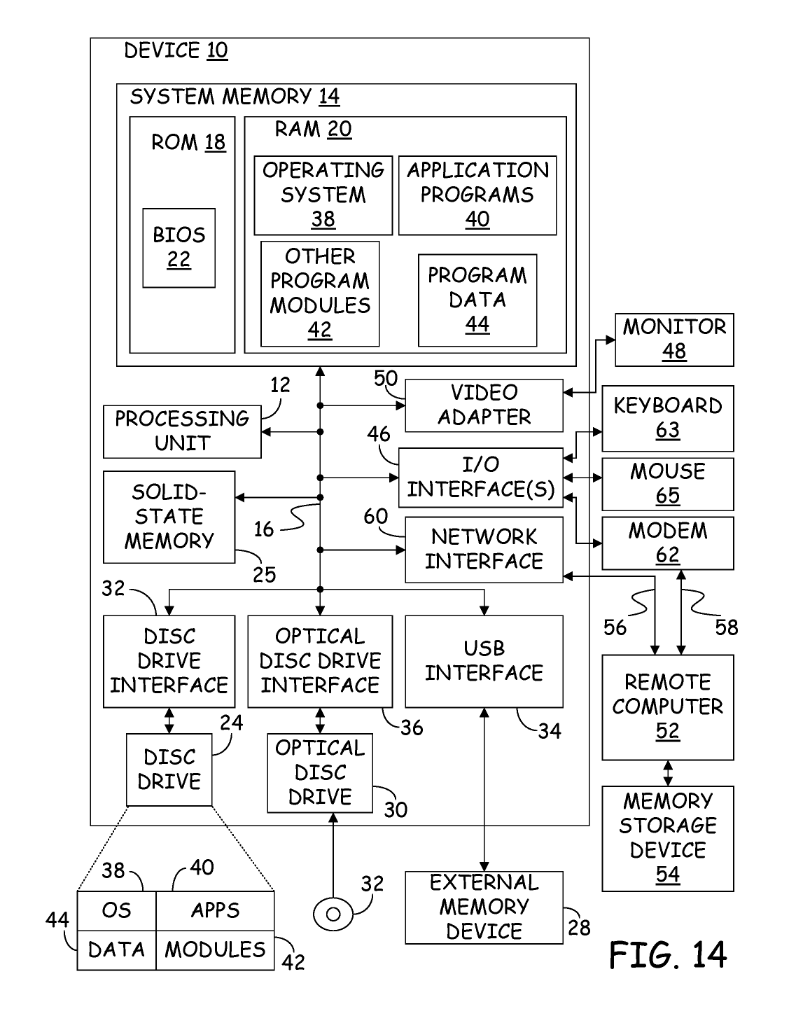

FIG. 14 provides an example of a computing device 10 that can be used as a client device, server device, data processing device or data warehouse device in the embodiments above. Computing device 10 includes a processing unit 12, a system memory 14 and a system bus 16 that couples the system memory 14 to the processing unit 12. System memory 14 includes read only memory (ROM) 18 and random access memory (RAM) 20. A basic input/output system 22 (BIOS), containing the basic routines that help to transfer information between elements within the computing device 10, is stored in ROM 18. Computer-executable instructions that are to be executed by processing unit 12 may be stored in random access memory 20 before being executed.

Embodiments of the present invention can be applied in the context of computer systems other than computing device 10. Other appropriate computer systems include handheld devices, multi-processor systems, various consumer electronic devices, mainframe computers, and the like. Those skilled in the art will also appreciate that embodiments can also be applied within computer systems wherein tasks are performed by remote processing devices that are linked through a communications network (e.g., communication utilizing Internet or web-based software systems). For example, program modules may be located in either local or remote memory storage devices or simultaneously in both local and remote memory storage devices. Similarly, any storage of data associated with embodiments of the present invention may be accomplished utilizing either local or remote storage devices, or simultaneously utilizing both local and remote storage devices.

Computing device 10 further includes a hard disc drive 24, an external memory device 28, and an optical disc drive 30. External memory device 28 can include an external disc drive or solid state memory that may be attached to computing device 10 through an interface such as Universal Serial Bus interface 34, which is connected to system bus 16. Optical disc drive 30 can illustratively be utilized for reading data from (or writing data to) optical media, such as a CD-ROM disc 32. Hard disc drive 24 and optical disc drive 30 are connected to the system bus 16 by a hard disc drive interface 32 and an optical disc drive interface 36, respectively. The drives and external memory devices and their associated computer-readable media provide nonvolatile storage media for the computing device 10 on which computer-executable instructions and computer-readable data structures may be stored. Other types of media that are readable by a computer may also be used in the exemplary operation environment.

A number of program modules may be stored in the drives and RAM 20, including an operating system 38, one or more application programs 40, other program modules 42 and program data 44. In particular, application programs 40 can include programs for implementing business continuity system 108, for example. Program data 44 may include data such as continuity plan info 111, activity log records 141, resiliency score details 126 and reports 131, for example.

Input devices including a keyboard 63 and a mouse 65 are connected to system bus 16 through an Input/Output interface 46 that is coupled to system bus 16. Monitor 48 is connected to the system bus 16 through a video adapter 50 and provides graphical images to users. Other peripheral output devices (e.g., speakers or printers) could also be included but have not been illustrated. In accordance with some embodiments, monitor 48 comprises a touch screen that both displays input and provides locations on the screen where the user is contacting the screen.

The computing device 10 may operate in a network environment utilizing connections to one or more remote computers, such as a remote computer 52. The remote computer 52 may be a server, a router, a peer device, or other common network node. Remote computer 52 may include many or all of the features and elements described in relation to computing device 10, although only a memory storage device 54 has been illustrated in FIG. 14. The network connections depicted in FIG. 14 include a local area network (LAN) 56 and a wide area network (WAN) 58. Such network environments are commonplace in the art.

The computing device 10 is connected to the LAN 56 through a network interface 60. The computing device 10 is also connected to WAN 58 and includes a modem 62 for establishing communications over the WAN 58. The modem 62, which may be internal or external, is connected to the system bus 16 via the I/O interface 46.

In a networked environment, program modules depicted relative to the computing device 10, or portions thereof, may be stored in the remote memory storage device 54. For example, application programs may be stored utilizing memory storage device 54. In addition, data associated with an application program may illustratively be stored within memory storage device 54. It will be appreciated that the network connections shown in FIG. 14 are exemplary and other means for establishing a communications link between the computers, such as a wireless interface communications link, may be used.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms for implementing the claims.

What is claimed is:

1. A method comprising:
receiving scores for individual components of a continuity plan;
forming a plan resiliency score from the scores for the individual components;
selecting text based on the plan resiliency score; and
embedding the selected text in a user interface.

2. The method of claim 1 further comprising providing a scoring guide in a user interface to indicate how a score for an individual component of a continuity plan can be increased.

3. The method of claim 1 further comprising:
receiving scores for individual components of a plurality of continuity plans, each plan associated with a separate team or area of a business;
forming a separate resiliency score for each continuity plan; and
forming a report user interface comprising scores for at least two continuity plans.

4. The method of claim 1 further comprising providing user interfaces to allow at least one business continuity activity to be logged to form an activity log, wherein the score for at least one component is based on an activity log.

5. The method of claim 4 wherein the user interface allows a business continuity activation to be logged to form the activity log.

6. The method of claim 4 wherein the user interface allows at least one business continuity activity to be logged includes controls for entering whether a vendor took part in the activity.

7. The method of claim 1 wherein the steps of receiving scores, forming a plan resiliency score, selecting text, and embedding the selected text are performed multiple times and wherein the method further comprises generating a report user interface that shows a change in plan resiliency scores over time.

8. A system comprising:
a continuity planning tool for entering information about an extent of a business continuity plan; and
a plan scoring tool for scoring a business continuity plan based on the information entered using the continuity planning tool, the plan scoring tool producing a resiliency score details user interface that comprises a resiliency score for the business continuity plan.

9. The system of claim 8 wherein the resiliency score details user interface further comprises scores for individual components of the business continuity plan.

10. The system of claim 8 wherein the resiliency score details user interface comprises text that is automatically selected based on the resiliency score details.

11. The system of claim 8 further comprising a reporting tool for reporting a plurality of resiliency scores for a plurality of respective teams.

12. The system of claim 8 further comprising an activities log tool for logging business continuity activities.

13. The system of claim 12 wherein the activities log tool comprises at least one user interface for logging an actual activation of a business continuity plan.

14. The system of claim 8 further comprising a business continuity plan scoring guide that provides indications of how to improve a resiliency score for a business continuity plan and the standards by which to assess and score the business continuity plan.

15. Computer-readable hardware having stored thereon computer-executable instructions that when executed by a processor cause the processor to perform steps comprising: providing at least one user interface to record information about a business continuity plan;
providing at least one user interface to score elements of the business continuity plan based on the recorded information;
calculating a resiliency score for the business continuity plan based on the scores for the elements of the business continuity plan; and
providing at least one user interface comprising the resiliency score for the business continuity plan.

16. The computer-readable hardware of claim 15 wherein the step of providing at least one user interface comprising the resiliency score for a business continuity plan comprises displaying text and a color marker that are automatically selected based on the resiliency score.

17. The computer-readable hardware of claim 15 further comprising providing at least one user interface reporting resiliency scores for a plurality of teams in a business.

18. The computer-readable hardware of claim 15 further comprising providing at least one user interface to record a business continuity activity.

19. The computer-readable hardware of claim 18 wherein providing at least one user interface to record a business continuity activity comprises providing at least one user interface to record an actual activation of the business continuity plan.

20. The computer-readable hardware of claim 15 further comprising providing at least one user interface displaying a scoring guide that provides indications of how a resiliency score can be increased.
